(19) United States
(12) Patent Application Publication
(10) Pub. No.: US 2025/0328742 A1
(43) Pub. Date: Oct. 23, 2025

(54) Wearable Computer with Angled Imaging Device

(71) Applicant: ZABRA TECHNOLOGIES CORPORATION, Lincolnshire, IL (US)

(72) Inventors: Ricardo F. Perez, New Haven, CT (US); Chandra M. Nair, Mount Sinai, NY (US); Sunghun Lim, Bethpage, NY (US); Chieh Kai Wang, Taichung City (TW)

(21) Appl. No.: 18/639,782

(22) Filed: Apr. 18, 2024

(51) Int. Cl. G06K 7/10

(52) U.S. Cl. CPC G06K 7/10891; G06K 7/1095

(57) ABSTRACT

Wearable computers with angled imaging devices are disclosed herein. An example wearable computer with angled imaging device includes wearable computing device, including an imaging device, defining an imaging direction, wherein the imaging direction is a central axis of a field of view of the imaging device; a display, defining a normal direction of the display which is configured to face eyes of a user; and a wearable mounting apparatus, configured to interface with a forearm of a user; wherein the imaging direction and the normal direction, when projected onto a reference plane parallel to both the imaging direction and the normal direction, are offset by a first predetermined, non-orthogonal angle.

### BACKGROUND

Wearable computers with imaging functionality are regularly used by warehouse and delivery workers to aid in process documentation and parcel tracking. Wearable computers may be cumbersome and require repeated physical manipulation to engage with the display, buttons or keys, and camera of the device, which over the course of a period of use, may impair the integrity of the attachment to a user and cause considerable fatigue.

### SUMMARY

In an embodiment, the present invention is a wearable computing device, including an imaging device, defining an imaging direction, wherein the imaging direction is a central axis of a field of view of the imaging device, a display, defining a normal direction of the display which is configured to face eyes of a user, and a wearable mounting apparatus, configured to interface with a forearm of a user, wherein the imaging direction and the normal direction, when projected onto a reference plane parallel to both the imaging direction and the normal direction, are offset by a first predetermined angle (A₁), where A₁ is non-orthogonal.

In a variation of this embodiment, A₁ is selected from a range defined between 110 degrees and 115 degrees.

In a variation of this embodiment, A₁ is 112 degrees.

In a variation of this embodiment, the wearable computing device has an engaged configuration relative to the user and the engaged configuration is defined wherein a forearm is positioned such that a longitudinal axis of the forearm is substantially orthogonal to a direction of gravity, the wearable computing device is disposed on the forearm in a position in which the normal direction substantially faces the eyes of the user, and the direction of gravity is parallel to the reference plane, the imaging direction is at a second predetermined angle (A₂) relative to the direction of gravity, when projected onto the reference plane, and the normal direction is at a third predetermined angle (A₃) relative to the direction of gravity, when projected onto the reference plane.

In a variation of this embodiment, A₂ is 90 degrees.

In a variation of this embodiment, A₃ is selected from a range defined between 155 to 160 degrees.

In a variation of this embodiment, A₃ is 158 degrees.

In a variation of this embodiment, the imaging device includes a camera.

In a variation of this embodiment, the imaging device includes an optical scanner.

In a variation of this embodiment, the mounting apparatus comprises straps, configured to secure the wearable computing device to the forearm.

In a variation of this embodiment, the mounting apparatus is secured to the wearable computing device by a connection type selected from the group consisting of a cantilevered snap fit connection, an annular snap fit connection, a torsional snap fit connection, a magnetic connection, and a threaded connection.

In another embodiment, the present invention is a wearable computing device, including an imaging device, defining an imaging direction, and a display, defining a normal direction of the display which is configured to face eyes of a user, wherein the imaging direction and the normal direction, when projected onto a reference plane parallel to both the imaging direction and the normal direction, are offset by 112 degrees.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIGS. 1A-1C illustrate views of an example wearable computer with angled imaging device, according to embodiments of the present disclosure.

FIGS. 2A-2B illustrate views of an example wearable computer with angled imaging device disposed on a user in an engaged position, according to embodiments of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

Some of the figures of the present disclosure are drawn with reference to a shared cartesian coordinate system (mutually perpendicular X, Y, and Z axes), indicated by a compass in the lower left corner of the concerned figures. The devices disclosed herein may be oriented and manipulated in a number of ways, and the shared coordinate system is intended only to aid in understanding, and not to define or limit the subject matter of the disclosure.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The technology of the present disclosure generally pertains to wearable computers, wearable computing devices and the like. Wearable computers are typically employed by warehouse workers and delivery workers (as limited examples), as a means of documenting and tracking various parcels, packages, items of manufacture to be shipped, and the like. Such wearable computers often include imaging capabilities, via a camera, scanner, or similar device, which allows the user to photograph or scan the parcels for documentation purposes, or for receiving directions for actions to be performed pertaining to a given parcel. Wearable computers are typically worn on the forearm of a user, or attached to a belt and hung at the side of the user until needed. The present disclosure is primarily concerned with the former, that is, forearm mounted wearable computers. As technology has progressed to the state of the present day, single device integration has proven to be the evolutionary direction of most device developers. In the past, a forearm mounted wearable computer may have had a forearm mounted display for viewing, and interfaced with a separate handheld scanner, connected via a wire or wireless connection. Presently, wearable computers with optical devices have, like so many other types of devices, been integrated.

Wearable computers with integrated optical devices suffer certain drawbacks. As an example, depending on the configuration or orientation of the optical device relative to the display, a user may have to orient the device in a first manner to easily view the display, and orient the device in a second manner to effectively employ the optical device. These changes in orientation often involve a user repeatedly rotating their forearm in a back-and-forth fashion to index between the two orientations. As most wearable computers are secured to the forearm by some manner of strap, this repeated motion is liable to loosen the straps, such that the wearable computer is no longer secure, and slides around the forearm in an undesirable manner.

The technology of the present disclosure may provide a solution to the above-described problem. The wearable computer (e.g., device 100) includes a display and optical device oriented in a specific configuration, such that a user, with the wearable computer disposed on their forearm, does not have to move their forearm to index between configurations to view the display and operate the optical device effectively. The optical device has a field of view, the center of which is angled 22 degrees askew from the plane of the display, thus a user may photograph or scan a parcel directly in front of the user while simultaneously viewing the display at a comfortable angle that does not require forearm rotation or craning of the neck. Thus, the wearable computer is not subject to near-constant repeated rotation of the forearm jeopardizing the integrity of the attachment via the straps (or other mechanism). Repetitive supination and pronation of the arm is a non-value adding movement, which may increase fatigue by as much as 60 percent and reduce productivity by as much as 30 percent.

Moreover, the angled optical device facilitates a configuration of the device as a whole, such that a battery pack can also be favorably angled, resulting in a configuration where the wearable computer is well balanced on the user's forearm, while both the optical device and display are favorably engageable. Note that this configuration does not preclude a need for straps, as a user will not always orient the wearable computer in this engaged position, and straps or other mechanisms for attachment remain necessary when the user is in other positions.

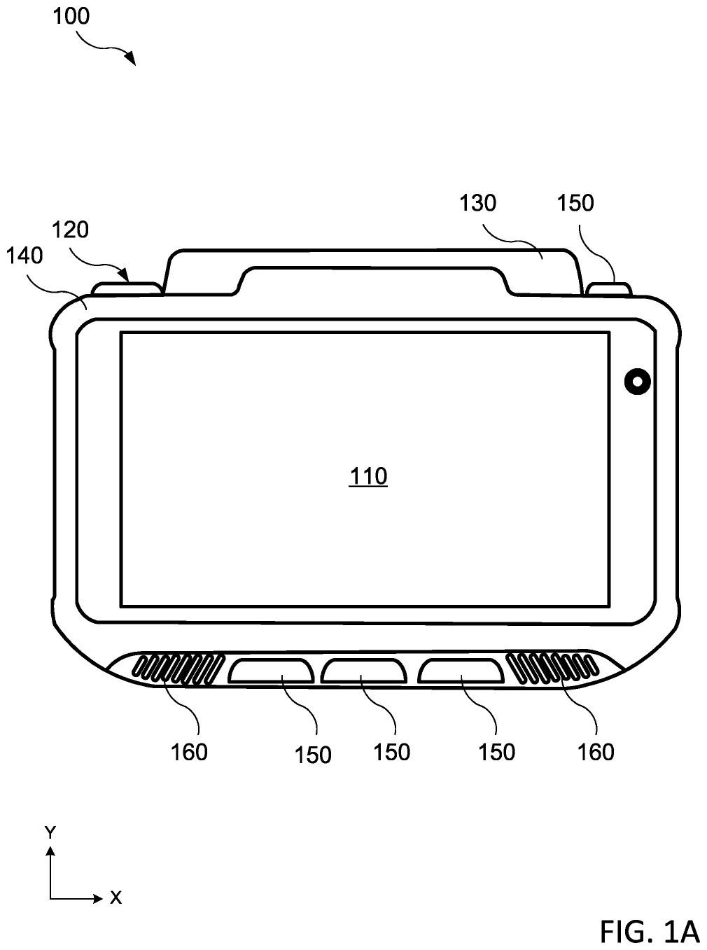

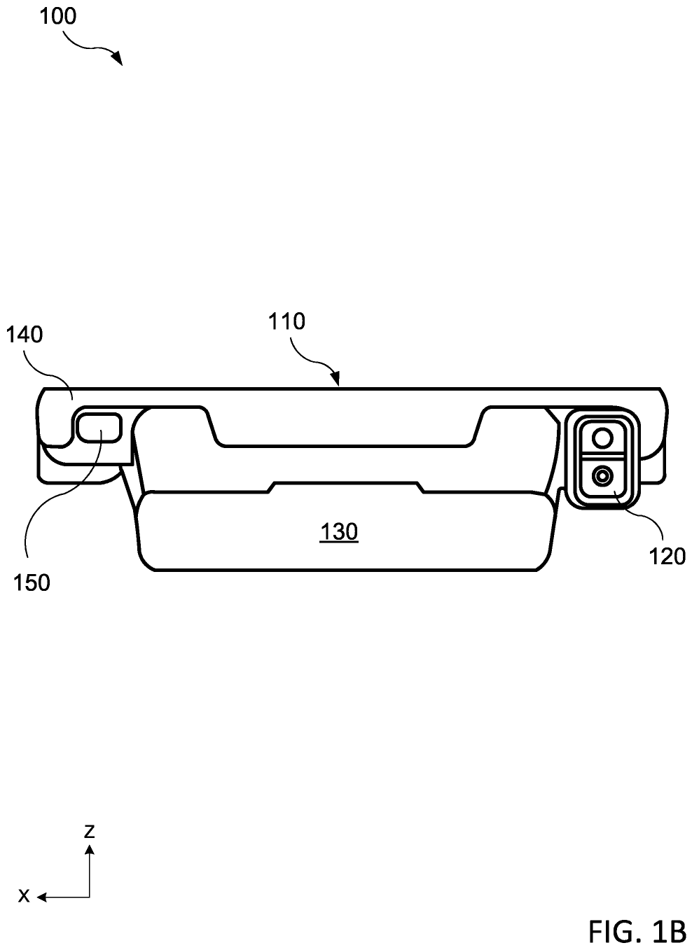

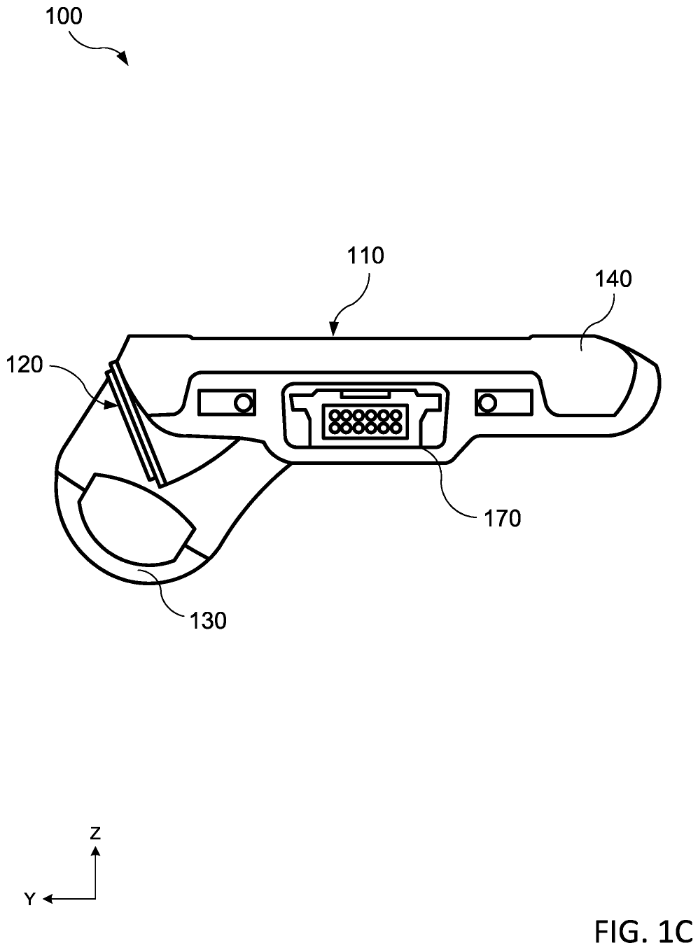

Turning now to the figures, FIGS. 1A-1C illustrate profile views of a device 100 (e.g., a wearable computer, wearable computing device). The device 100 may include a display 110 (e.g., a liquid crystal display (LCD), a light-emitting diode (LED) display, an organic LED (OLED) display, an active-matrix OLED (AMOLED) display, a passive-matrix OLED (PMOLED) display, a quantum dot LED (QLED) display), and an imaging device 120 (e.g., a camera, an optical scanner). The device 100 may further include various conventional structures of computers and portable computing devices, such as a battery 130 e.g., detachable battery pack, integrated battery) a charging apparatus 170, electro-acoustic transducer(s) 160 (e.g., speakers, microphone), assorted functional buttons 150, a keypad, a housing 140, a processor, a memory, computer circuitry and the like. Furthermore, this disclosure does not intend to define or limit the scope of the computer programs installed on the computing device, nor the computing functions executable by the device.

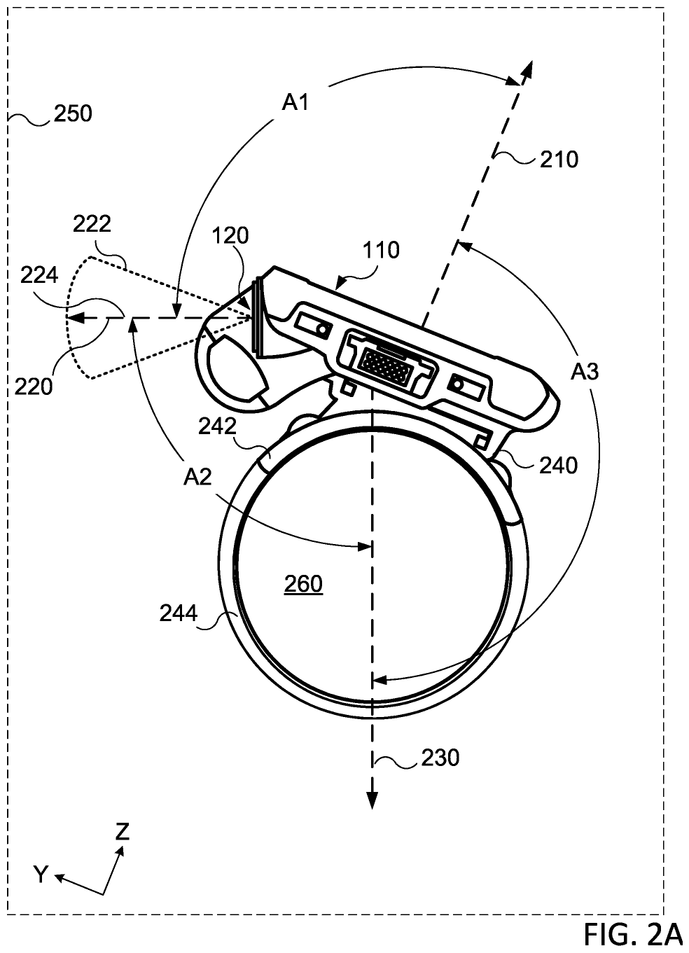

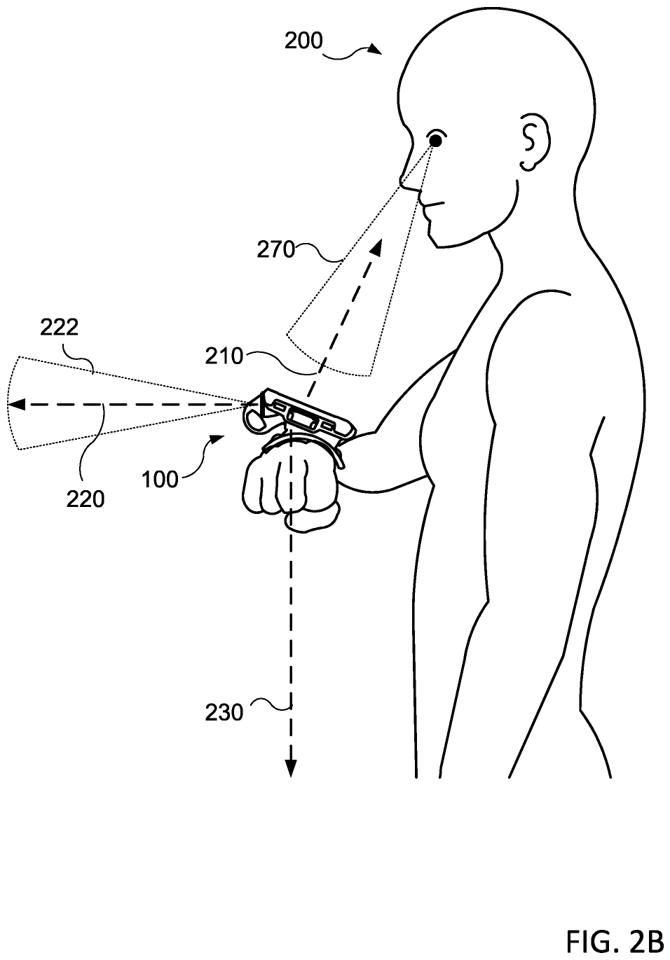

FIGS. 2A-2B illustrate the device 100 disposed on a forearm 260 (section view in FIG. 2A) of a user 200 (FIG. 2B), according to embodiments of the present disclosure. The device 100 is secured to the forearm via a mounting apparatus 240 which is configured to interface with both the forearm 260 of the user 200 and the device 100.

According to some embodiments, the mounting apparatus 240 includes a curved surface 242 to interface with the forearm 260 and may further include straps 244 to ensure a secure fit when installed. The mounting apparatus 240 further includes a means of attachment to the device 100, which may include one or more of a snap connection (e.g., cantilevered snap fit, an annular snap fit, a torsional snap fit), a threaded connection, a magnetic connection, and the like.

According to some embodiments, the imaging device 120 defines a field of view 222 having a central axis 224, which defines the imaging direction 220 of the imaging device 120. In generally applicable context, the imaging direction 220 is the direction of the axis emanating orthogonally outward from the geometric center of a lens of the imaging device 120, which is, by convention, the central axis 224 of the field of view 222.

In the illustrated embodiment, the display 110 defines a normal direction 210, which is defined as the direction orthogonal to, and away from, a display plane parallel to the surface of the display 110. The normal direction 210 and the imaging direction 220 can then be used to define a reference plane 250, where the reference plane 250 is a plane in the set of planes that are parallel to both the normal direction 210 and the imaging direction 220. Thus, the vectors defining the imaging direction 220 and the normal direction 210 can be projected into the reference plane 250 without the loss of a vector component in a third dimension. As illustrated, the reference plane 250 includes both the Y-axis and the Z-axis.

According to some embodiments, a first angle A₁ defined as the angle measured between the normal direction 210 and the imaging direction 220 as projected in the reference plane 250. A second angle, A₂, is defined as the angle between the imaging direction 220 and the direction of gravity 230, as projected in the reference plane 250. A third angle, A₃ is defined as the angle between the normal direction 210 and the direction of gravity 230 as projected in the reference plane 250.

A₁ is defined by the construction of the device 100, and the value of A₁ does not vary with orientation or other environmental factors but may vary between the housings of different embodiments. A₂ and A₃ are not defined by the construction of the device and are governed by the orientation in which a user chooses to orient the device 100. Furthermore, A₂ and A₃ are only of relevance when the user orients the device 100 in the engaged position.

According to some embodiments, the engaged position is defined using the reference plane 250, and A₂ or A₃. As illustrated in FIG. 2B, the user 200 has oriented the device 100 in the engaged position, which is defined where the direction of gravity 230 is coplanar (within tolerances) with the reference plane 250, A₂ is measured at 90 degrees (within tolerances), A₃ is consequently measured at 158 degrees (within tolerances), and the normal direction 210 is oriented towards the user. In terms of the orientation of the user 200 with reference to the engaged position, the user 200 positions their forearm 260 in front of their torso, such that an axis of the forearm 260 is substantially perpendicular to the direction of gravity 230 and substantially parallel to a direction of the collarbone of the user 200. Stated differently, the engaged position is similar to the position the user 200 might take to observe a wristwatch on their wrist.

According to some embodiments, the device 100 is configured such that in the engaged configuration the imaging direction 220 of the device 100 faces forward relative to the perspective of the user, and the normal direction 210 is incident with a field of view 270 of the user 200, when the head and eyes of the user 200 are comfortably positioned. As used herein, the term “comfortably positioned” refers to a natural, forward-facing position of the user 200, preferably having less than 10 degrees of rotational movement of the head of the user 200 about the neck of the user 200 in any direction, and negligible translational movement of the head of the user 200. When the device 100 is oriented in the engaged position by the user 200, the user preferably must move only the eyes of the user 200 for the field of view of the user to become compatibly incident with the normal direction 210 of the device 100, such that the display 110 is easily viewable. The term “compatibly incident” may vary between users but is defined herein to be in a range where the angle of incidence between a field of view of the user 200 and the normal direction 210 is between 160 degrees and 180 degrees.

According to some embodiments, A₁ is measured at 112 degrees (within tolerances). Constructing the device 100 where the measure of A₁ at 112 degrees has been found to facilitate an increased degree of ease of use of the device 100 in the engaged position.

As a counterexample, in a hypothetical embodiment where A₁ is 90 degrees, the engaged position as defined would not be feasible. In such an example, A₂ remains 90 degrees, and the imaging direction 220 would be directed forward, as illustrated in FIG. 2B, but notably, the normal direction 210 would be antiparallel with gravity, or in otherwards, vertical. When the normal direction 210 is vertical, the user must either rotate the forearm 206, such that the normal direction becomes compatibly incident with the field of view 270 of the user 200 or crane the neck in order to orient the head such that the field of view 270 of the user 200 becomes compatibly incident with the normal direction 210. In the first instance, where the user 200 rotates the forearm 260, the imaging direction 220 is altered, which may impair the imaging functionality of the imaging device 120, for which the forearm 260 may be rotated back to restore. If a user 200 is continuously rotating the forearm 260 back and forth to transition between imaging functionality of the imaging device 120 and viewability of the display 110, the mounting apparatus 240 may become progressively destabilized, or the straps 244 loosened. In the second instance where the user 200 must crane the neck to view the display, such an orientation might cause discomfort to the user 200.

According to some embodiments, configuring the device A₁ to be measured at 112 degrees, or within the range of 110 to 115, to avert the scenarios described in the above hypothetical counterexample. As illustrated in FIGS. 2A-2B, the A₁ measuring at 112 degrees results in a forward-facing imaging direction 220, as well as a user-facing normal direction 210, which is compatibly incident with the field of view 270 of the user.

Furthermore, the device 100 is configured such that when the user 200 orients the device 100 in the engaged position, that the weight distribution of the device 100 is mutually compatible with the position. The center of gravity of the device 100, when in the engaged position, is vertically aligned (within tolerances) with the radial center of the forearm 260. Thus, in the engaged position, the device 100 is not gravitationally inclined to slide one way or another about the forearm 260, which may reduce strain on the straps 144, thus reducing need to readjust the device 100 at various intervals during a period of use.

### Experimental Data

TABLE 1

| Parameter | 0 Degree Angle | 22 Degree Angle |
|---|---|---|
| 1. Weight Shift | 3.5 | 4 |
| 2. Balance | 3 | 4.5 |
| 3. Stability | 3 | 4 |
| 4. Comfort | 3.5 | 4 |
| 5. Effort | 3 | 4.5 |
| Average | 3.25 | 4.25 |

Table 1 shows favorability ratings of users testing wearable computers across five parameters. The users tested a wearable computer with a 0-degree angle between the imaging direction and the plane of the display, as well as a wearable computer with a 22-degree angle between the imaging direction and the plane of the display (e.g., device 100). Regarding the first parameter, weight shift, users reported that the 0-degree wearable computer experienced substantial weight shifting when rotating the device back and forth between a viewing orientation and an imaging orientation, scoring the 0-degree wearable at a 3.5. Conversely, users reported less weight shifting with the 22-degree wearable computer, due to less supination and pronation required to operate the device.

With regard to the second parameter, balance, the 22-degree wearable computer exhibited a 1.5 point favorability increase over the 0 degree wearable computer. Further, the 22-degree wearable computer had a 1 point increase in the third parameter, stability, a 0.5 point increase in the fourth parameter, comfort, and a 1.5 point increase in the fifth parameter, effort, over the 0-degree wearable computer. Users reported a greater ease of functionality and ergonomic advantage across all parameters, citing less need for supination and pronation of the forearm, resulting in greater stability and comfort with minimal effort applied, tallying a 30% improvement in favorability of the 22-degree wearable computer over the 0 degree wearable computer.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A wearable computing device, comprising:
an imaging device, defining an imaging direction, wherein the imaging direction is a central axis of a field of view of the imaging device;
a display, defining a normal direction of the display which is configured to face eyes of a user; and
a wearable mounting apparatus, configured to interface with a forearm of a user;
wherein the imaging direction and the normal direction, when projected onto a reference plane parallel to both the imaging direction and the normal direction, are offset by a first predetermined angle (A₁), where A₁ is non-orthogonal.

2. The wearable computing device of claim 1, wherein A₁ is selected from a range defined between 110 degrees and 115 degrees.

3. The wearable computing device of claim 1, wherein A₁ is 112 degrees.

4. The wearable computing device of claim 1, wherein the wearable computing device has an engaged configuration relative to the user and the engaged configuration is defined wherein:
a forearm is positioned such that a longitudinal axis of the forearm is substantially orthogonal to a direction of gravity,
the wearable computing device is disposed on the forearm in a position in which the normal direction substantially faces the eyes of the user, and the direction of gravity is parallel to the reference plane,
the imaging direction is at a second predetermined angle (A₂) relative to the direction of gravity, when projected in the reference plane, and
the normal direction is at a third predetermined angle (A₃) relative to the direction of gravity, when projected onto the reference plane.

5. The wearable computing device of claim 4, wherein A₂ is 90 degrees.

6. The wearable computing device of claim 4, wherein A₃ is selected from a range defined between 155 to 160 degrees.

7. The wearable computing device of claim 4, wherein A₃ is 158 degrees.

8. The wearable computing device of claim 1, wherein the imaging device comprises a camera.

9. The wearable computing device of claim 1, wherein the imaging device comprises an optical scanner.

10. The wearable computing device of claim 1, wherein the mounting apparatus comprises straps, configured to secure the wearable computing device to the forearm.

11. The wearable computing device of claim 1, wherein the mounting apparatus is secured to the wearable computing device by a connection type selected from the group consisting of a cantilevered snap fit connection, an annular snap fit connection, a torsional snap fit connection, a magnetic connection, and a threaded connection.

12. A wearable computing device, comprising:
an imaging device, defining an imaging direction; and
a display, defining a normal direction of the display which is configured to face eyes of a user; wherein the imaging direction and the normal direction, when projected onto a reference plane parallel to both the imaging direction and the normal direction, are offset by 112 degrees.
